(19) United States
(12) Patent Application Publication
(10) Pub. No.: US 2018/0365650 A1
(43) Pub. Date: Dec. 20, 2018

(54) MOBILE TERMINAL AND CONTROL METHOD THEREOF

(71) Applicant: LG ELECTRONICS INC., Seoul (KR)

(72) Inventors: Hyukjae JANG, Seoul (KR); Jieun KIM, Seoul (KR); Youngyeon SEO, Seoul (KR); Minho LEE, Seoul (KR)

(73) Assignee: LG ELECTRONICS INC., Seoul (KR)

(21) Appl. No.: 15/737,052

(22) PCT Filed: Nov. 30, 2015
(86) PCT No.: PCT/KR2015/012932

§ 371 Date: Dec. 15, 2017

(30) Foreign Application Priority Data
Jul. 22, 2015 (KR) 10-2015-0103585

(51) Int. Cl. G06Q 10/10; H04M 1/725; H04W 4/029

(52) U.S. Cl. CPC G06Q 10/1093; H04W 4/029; H04M 1/72572; H04M 1/72566

(57) ABSTRACT

A mobile terminal and controlling method thereof are disclosed. The present invention includes a display unit configured to display information related to the mobile terminal, a wireless communication unit configured to receive first information corresponding to a user of each of a plurality of external devices from an external server or a plurality of the external devices, wherein the first information including at least one of location information of the external device, personal information of the user of the external device, schedule information of the user of the external device, or history information of the user of the external device, and a controller configured to execute a schedule management application, to control the display unit to display an execution screen of the executed schedule management application, to assign a duty of handling the registered schedule to at least one of a user of the mobile terminal and the user of each of the plurality of the external devices based on the received first information and second information corresponding to a schedule registered via the schedule management application, and to control the wireless communication unit to transmit a result of the assignment of the handling duty assignment to the external server or the plurality of the external devices.

### TECHNICAL FIELD

The present invention relates to a mobile terminal, and more particularly, to a mobile terminal and controlling method thereof. Although the present invention is suitable for a wide scope of applications, it is particularly suitable for facilitating the use of a terminal in further consideration of user's convenience.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players.

More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

Meanwhile, a schedule management application is generally installed in a mobile terminal and a user is able to manage a schedule through the mobile terminal. However, it is usually difficult for the user to manage a joint job, which is not a schedule related to the user, or other people's schedules.

### DISCLOSURE OF THE INVENTION

### Technical Task

Accordingly, an object of the present invention is to address the above-noted and other problems. One object of the present invention is to provide a solution for assigning a duty of handling a schedule to a user most appropriate for performing a prescribed schedule among users of a plurality of mobile terminals interworking with each other if the prescribed schedule is registered through a schedule management application.

Technical tasks obtainable from the present invention are non-limited by the above-mentioned technical tasks. And, other unmentioned technical tasks can be clearly understood from the following description by those having ordinary skill in the technical field to which the present invention pertains.

### Technical Solutions

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings. To achieve these and other advantages and in accordance with the purpose of the present invention, as embodied and broadly described, a mobile terminal according to one embodiment of the present invention includes a wireless communication unit configured to receive a 1st information corresponding to a user of each of a plurality of external devices from an external server or a plurality of the external devices and a controller, wherein the 1st information comprise at least one selected from the group consisting of a location information of the external device, a personal information of the user of the external device, a schedule information of the user of the external device, and a history information of the user of the external device, wherein the controller runs a schedule management application, wherein based on the received 1st information and a 2nd information corresponding to a schedule registered through the schedule management application, the controller assigns a duty of handling the registered schedule to at least one of a user of the mobile terminal and the user of each of a plurality of the external devices, and wherein the controller controls the wireless communication unit to send a result of the assignment of the handling duty assignment to the external server or a plurality of the external devices.

To further achieve these and other advantages and in accordance with the purpose of the present invention, as embodied and broadly described, a method of controlling a mobile terminal according to one embodiment of the present invention includes the steps of receiving a 1st information corresponding to a user of each of a plurality of external devices from an external server or a plurality of the external devices, the 1st information comprising at least one selected from the group consisting of a location information of the external device, a personal information of the user of the external device, a schedule information of the user of the external device, and a history information of the user of the external device, running a schedule management application, based on the received 1st information and a 2nd information corresponding to a schedule registered through the schedule management application, assigning a duty of handling the registered schedule to at least one of a user of the mobile terminal and the user of each of a plurality of the external devices, and sending a result of the assignment of the handling duty assignment to the external server or a plurality of the external devices.

### Advantageous Effects

Effects of a mobile terminal and controlling method thereof according to the present invention are described as follows.

First of all, according to one embodiment of the present invention, if a schedule is registered through a schedule management application, it is able to provide a solution for assigning a duty of handling a schedule to a user most appropriate for performing the schedule among users of a plurality of mobile terminals interworking with each other.

### DESCRIPTION OF DRAWINGS

FIG. 1A is a block diagram to describe a mobile terminal related to the present invention.

FIG. 1B and FIG. 1C are conceptual diagrams for one example of a mobile terminal related to the present invention in different views.

FIG. 2 is a conceptual view of a deformable mobile terminal according to an alternative embodiment of the present disclosure;

FIG. 3 is a conceptual view of a wearable mobile terminal according to another alternative embodiment of the present disclosure;

FIG. 4 is a conceptual view of a wearable mobile terminal according to another alternative embodiment of the present disclosure.

FIG. 5 is a flowchart to describe one example of a method of if a schedule is registered through a schedule management application in a mobile terminal, assigning a duty of handling the schedule to at least one of a user of the mobile terminal and users of a plurality of external devices according to one embodiment of the present invention;

FIG. 6 is a diagram to describe one example of a method of sharing information for schedule management between a mobile terminal and an external device according to one embodiment of the present invention;

FIG. 7 is a diagram to describe one example of a method of if a schedule is registered through a schedule management application in a mobile terminal, assigning a duty of handling the schedule to at least one of a user of the mobile terminal and users of a plurality of external devices according to one embodiment of the present invention;

FIG. 8 is a diagram to describe one example of a method of registering a schedule through a schedule management application in a mobile terminal according to one embodiment of the present invention;

FIG. 9 is a diagram to describe one example of a method of providing a notification of a schedule registered in a mobile terminal according to one embodiment of the present invention;

FIG. 10 is a diagram to describe one example of a method of detecting a completion of a schedule registered in a mobile terminal according to one embodiment of the present invention;

FIG. 11 is a diagram to describe one example of a method of if a schedule is registered through a schedule management application in a mobile terminal, assigning a duty of handling the schedule to at least one of a user of the mobile terminal and users of a plurality of external devices according to one embodiment of the present invention;

FIG. 12 is a diagram to describe one example of a method of if a schedule is registered through a schedule management application in a mobile terminal, determining a date appropriate for performing the registered schedule according to one embodiment of the present invention;

FIG. 13 is a diagram to describe another example of a method of if a schedule is registered through a schedule management application in a mobile terminal, assigning a duty of handling the schedule to at least one of a user of the mobile terminal and users of a plurality of external devices according to one embodiment of the present invention; and

FIG. 14 and FIG. 15 are diagrams to describe one example of a method of if a schedule is registered through a schedule management application in a mobile terminal, assigning a duty of handling the schedule to at least one of a user of the mobile terminal and users of a plurality of external devices according to one embodiment of the present invention.

### BEST MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc, may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

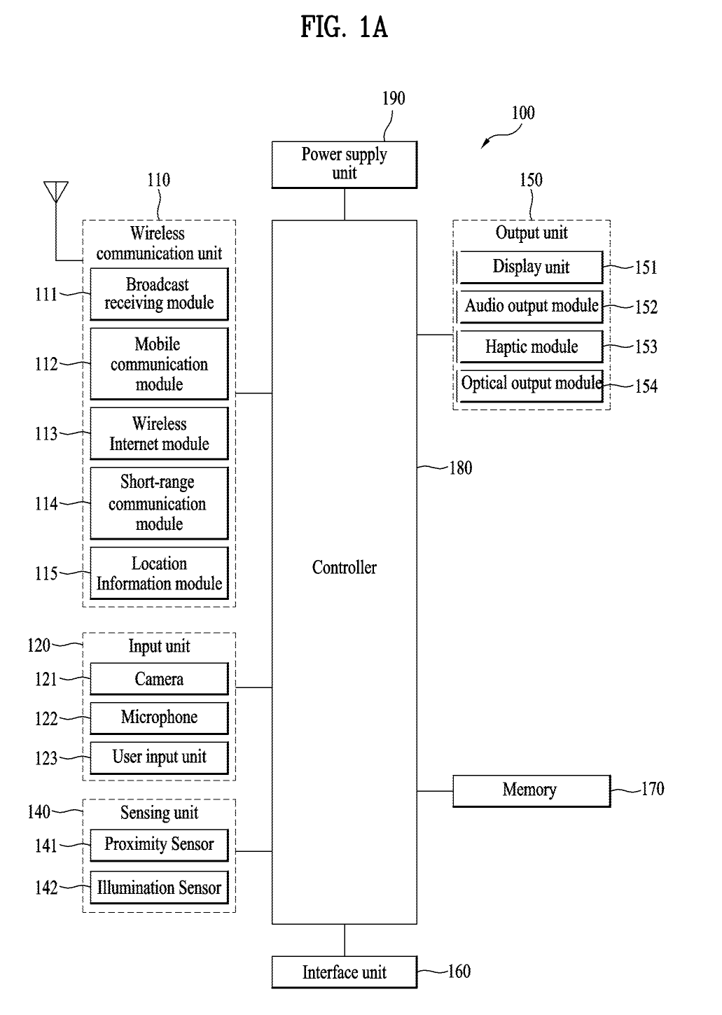

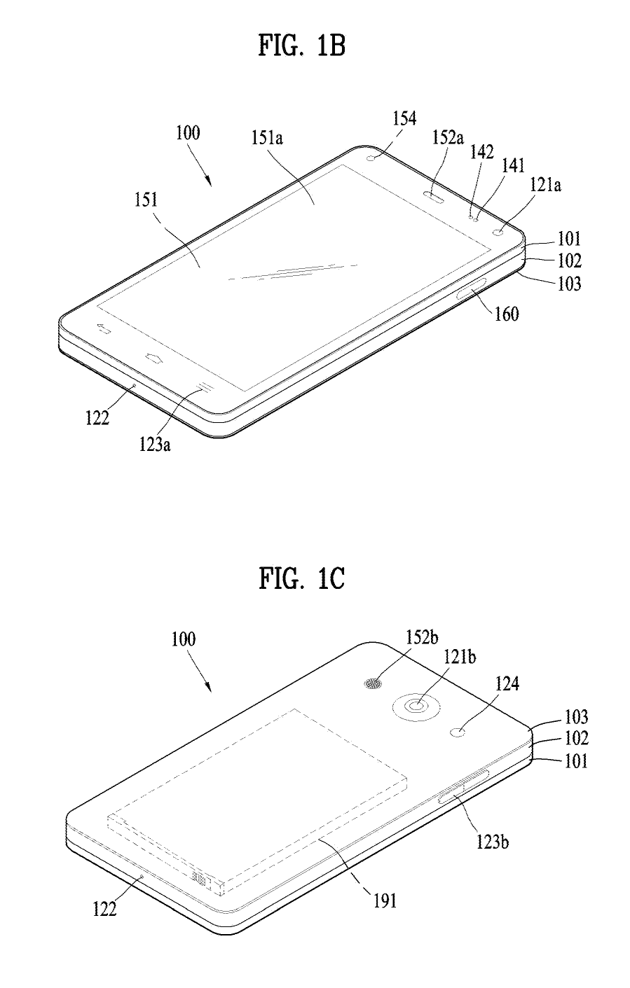

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

For instance, the wireless communication unit 110 typically includes one or more components which permit wireless communication between the mobile terminal 100 and a wireless communication system or network within which the mobile terminal is located.

The wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, and the like) for allowing a user to input information. Data (for example, audio, image, and the like) is obtained by the input unit 120 and may be analyzed and processed by controller 180 according to user commands thereof.

The sensing unit 140 is typically implemented using one or more sensors configured to sense internal information of the mobile terminal, the surrounding environment of the mobile terminal, user information, and the like. For example, in FIG. 1A, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160,

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170,

Moreover, the controller 180 controls some or all of the components illustrated in FIGS. 1A according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery ay be configured to be embedded in the terminal body, or configured to be detachable from the terminal body.

At least some of the above components can cooperatively operate to implement operations, controls and controlling methods of the mobile terminal according to various embodiments described in the following. The operations, controls or controlling methods of the mobile terminal can be implemented on the mobile terminal by running at least one application program saved to the memory 170.

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

System which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electro technical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO(Enhanced Voice-Data Optimized or Enhanced Voice-Data Only), Wideband CDMA (WCDMA), High Speed Downlink Packet access (HSDPA), HSUPA(High Speed Uplink Packet Access), Long Term Evolution (LTE) LTE-A(Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA(High Speed Uplink Packet Access), Long Term Evolution (LTE), LTE-A(Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Wi-Fi) and Wi-Fi Direct, and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information,

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e,g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense,

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data, Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 10, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof.

In this case, the terminal body can be construed as the concept of indicating the mobile terminal 100 as at least one assembly.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal includes a display unit 151, a first and a second audio output modules 151a/151b, a proximity sensor 141, an illumination sensor 142, an optical output module 154, a first and a second cameras 121a/121b, a first and a second manipulation units 123a/123b, a microphone 122, interface unit 160 and the like.

It will be described for the mobile terminal as shown in FIGS. 1B and 1C. The display unit 151, the first audio output module 151a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 151b and the second camera 121b are arranged in rear surface of the terminal body.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. For example, the display unit 151 may display an execution screen information of an application operated in the mobile terminal or User Interface, Graphic User Interface corresponding to the execution screen information.

The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

Moreover, the display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like.

In the present drawing, the first manipulation unit 123a is a touch key for example, by which the present invention is non-limited. For instance, the first manipulation unit 123 may include a push key (i.e., a mechanical key) or a combination of the touch key and the push key.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a users fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown adjacent to the second camera 121b. When an image of a subject is captured with the camera 121b, the flash 124 may illuminate the subject. The second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

The battery 191 may receive power via a power source cable connected to the interface unit 160. The battery 91 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Meanwhile, according to the present invention, information processed by a mobile terminal can be displayed using a flexible display. Regarding this, it shall be described in more detail with reference to the attached drawing in the following,

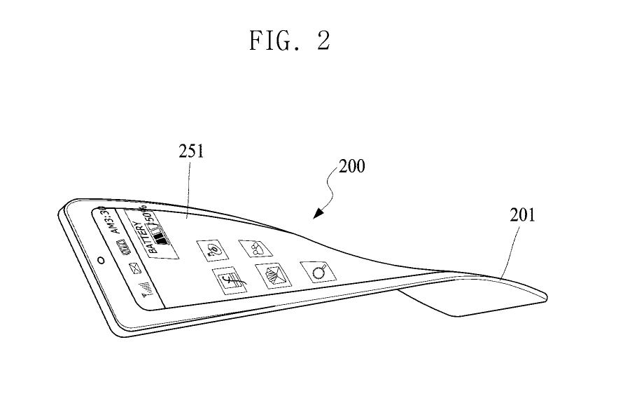

FIG. 2 is a perspective view illustrating one example of a watch-type mobile terminal 300 in accordance with another exemplary embodiment.

In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 251 is not deformed (for example, in a state with an infinite radius of curvature and referred to as a first state), a display region of the flexible display unit 251 includes a generally flat surface. When in a state that the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state (or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251,

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 may transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

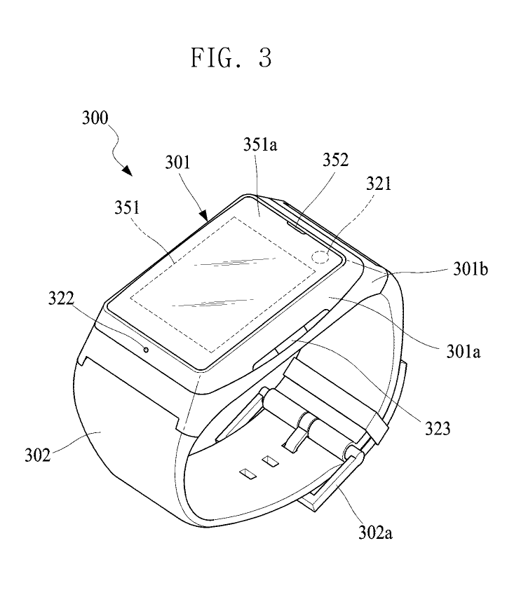

FIG. 3 is a perspective view illustrating one example of a watch-type mobile terminal 300 in accordance with another exemplary embodiment.

As illustrated in FIG. 3, the watch-type mobile terminal 300 includes a main body 301 with a display unit 351 and a band 302 connected to the main body 301 to be wearable on a wrist. In general, mobile terminal 300 may be configured to include features that are the same or similar to that of mobile terminal 100 of FIGS. 1A-1C.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference,

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

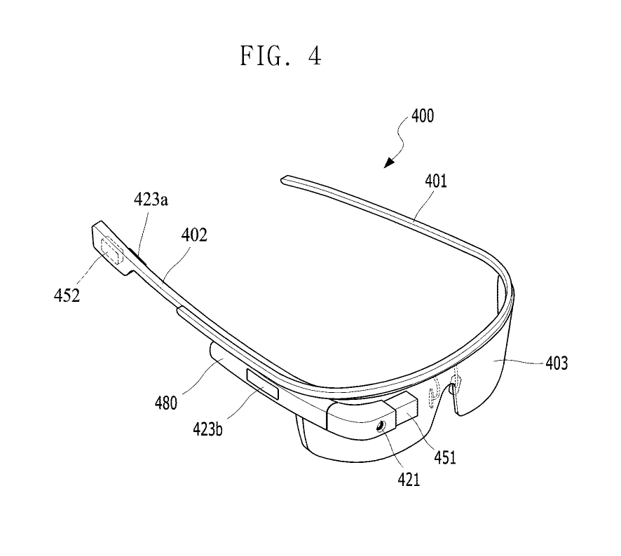

FIG. 4 is a perspective view illustrating one example of a glass-type mobile terminal 400 according to another exemplary embodiment.

The glass-type mobile terminal 400 can be wearable on a head of a human body and provided with a frame (case, housing, etc.) therefor. The frame may be made of a flexible material to be easily worn. The frame of mobile terminal 400 is shown having a first frame 401 and a second frame 402, which can be made of the same or different materials. In general, mobile terminal 400 may be configured to include features that are the same or similar to that of mobile terminal 100 of FIGS. 1A-1C.

The frame may be supported on the head and defines a space for mounting various components. As illustrated, electronic components, such as a control module 480, an audio output module 452, and the like, may be mounted to the frame part. Also, a lens 403 for covering either or both of the left and right eyes may be detachably coupled to the frame part.

The control module 480 controls various electronic components disposed in the mobile terminal 400. The control module 480 may be understood as a component corresponding to the aforementioned controller 180. FIG. 4 illustrates that the control module 480 is installed in the frame part on one side of the head, but other locations are possible.

The display unit 451 may be implemented as a head mounted display (HMD). The HMD refers to display techniques by which a display is mounted to a head to show an image directly in front of a user's eyes. In order to provide an image directly in front of the user's eyes when the user wears the glass-type mobile terminal 400, the display unit 451 may be located to correspond to either or both of the left and right eyes. FIG. 4 illustrates that the display unit 451 is located on a portion corresponding to the right eye to output an image viewable by the user's right eye.

The display unit 451 may project an image into the user's eye using a prism. Also, the prism may be formed from optically transparent material such that the user can view both the projected image and a general visual field (a range that the user views through the eyes) in front of the user.

In such a manner, the image output through the display unit 451 may be viewed while overlapping with the general visual field. The mobile terminal 400 may provide an augmented reality (AR) by overlaying a virtual image on a realistic image or background using the display,

The camera 421 may be located adjacent to either or both of the left and right eyes to capture an image. Since the camera 421 is located adjacent to the eye, the camera 421 can acquire a scene that the user is currently viewing.

The camera 421 may be positioned at most any location of the mobile terminal. In some embodiments, multiple cameras 421 may be utilized. Such multiple cameras 421 may be used to acquire a stereoscopic image.

The glass-type mobile terminal 400 may include user input units 423a and 423b, which can each be manipulated by the user to provide an input. The user input units 423a and 423b may employ techniques which permit input via a tactile input. Typical tactile inputs include a touch, push, or the like. The user input units 423a and 423b are shown operable in a pushing manner and a touching manner as they are located on the frame part and the control module 480, respectively.

If desired, mobile terminal 400 may include a microphone which processes input sound into electric audio data, and an audio output module 452 for outputting audio. The audio output module 452 may be configured to produce audio in a general audio output manner or an osteoconductive manner. When the audio output module 452 is implemented in the osteoconductive manner, the audio output module 452 may be closely adhered to the head when the user wears the mobile terminal 400 and vibrate the user's skull to transfer sounds.

A communication system which is operable with the variously described mobile terminals will now be described in more detail.

Such a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A(Long Term Evolution-Advanced)), Global System for Mobile Communications (GSM), and the like.

By way of a non-limiting example only, further description will relate to a CDMA communication system, but such teachings apply equally to other system types including a CDMA wireless communication system as well as OFDM(Orthogonal Frequency Division Multiplexing) wireless communication system.

A CDMA wireless communication system generally includes one or more mobile terminals (MT or User Equipment, UE) 100, one or more base stations (BSs, NodeB, or evolved NodeB), one or more base station controllers (BSCs), and a mobile switching center (MSC). The MSC is configured to interface with a conventional Public Switched Telephone Network (PSTN) and the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the CDMA wireless communication system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the mobile terminals 100 operating within the system. The broadcast receiving module 111 of FIG. 1A is typically configured inside the mobile terminal 100 to receive broadcast signals transmitted by the BT.

Global Positioning System (GPS) satellites for locating the position of the mobile terminal 100, for example, may cooperate with the CDMA wireless communication system. Useful position information may be obtained with greater or fewer satellites than two satellites. It is to be appreciated that other types of position detection technology, (i.e., location technology that may be used in addition to or instead of GPS location technology) may alternatively be implemented. If desired, at least one of the GPS satellites may alternatively or additionally be configured to provide satellite DMB transmissions.

The location information module 115 is generally configured to detect, calculate, or otherwise identify a position of the mobile terminal. As an example, the location information module 115 may include a Global Position System (GPS) module, a Wi-Fi module, or both. If desired, the location information module 115 may alternatively or additionally function with any of the other modules of the wireless communication unit 110 to obtain data related to the position of the mobile terminal.

A typical GPS module 115 can measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites. Furthermore, the GPS module can acquire speed information in real time to calculate a current position. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal, a wireless access point (AP) connected to the mobile terminal, and a database stored with wireless AP information.

The mobile terminal connected to the wireless AP may transmit a location information request message to the Wi-Fi location determination server.

The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AR

The information of the wireless AP extracted based on the location information request message of the mobile terminal 100 may include one or more of media access control (MAC) address, service set identification (SSID), received signal strength indicator (RSSI), reference signal received Power(RSRP), reference signal received quality(RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database.

A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information can be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter.

In addition to these position location methods, various algorithms may be used to extract (analyze) location information of a mobile terminal.

Such extracted location information may be transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 may be variously changed according to a wireless communication environment within which the mobile terminal 100 is positioned.

As previously described with regard to FIG. 1A, the mobile terminal may be configured to include short-range communication techniques such as Bluetooth™, Radio Frequency Identification (RFID), Infrared Data Association (IrDA), Ultra Wideband (UWB), ZigBee, Near Field Communication (NFC), Wireless USB(Wireless Universal Serial Bus), and the like.

A typical NFC module provided at the mobile terminal supports short-range wireless communication, which is a non-contactable type of communication between mobile terminals and generally occurs within about 10 cm. The NFC module may operate in one of a card mode, a reader mode, or a P2P mode. The mobile terminal 100 may further include a security module for storing card information, in order to operate the NFC module in a card mode. The security module may be a physical medium such as Universal Integrated Circuit Card (UICC) (e.g., a Subscriber Identification Module (SIM) or Universal SIM (USIM)), a secure micro SD and a sticker, or a logical medium (e.g., embedded Secure Element (SE)) embedded in the mobile terminal. Single Wire Protocol (SWP)-based data exchange may be performed between the NFC module and the security module.

In a case where the NFC module operates in a card mode, the mobile terminal may transmit card information on a general IC card to the outside. More specifically, if a mobile terminal having card information on a payment card (e. g, a credit card or a bus card) approaches a card reader, a short-range mobile payment may be executed. As another example, if a mobile terminal which stores card information on an entrance card approaches an entrance card reader, an entrance approval procedure may start. A card such as a credit card, a traffic card, or an entrance card may be included in the security module in the form of applet, and the security module may store card information on the card mounted therein. Card information for a payment card may include any of a card number, a remaining amount and usage history, and the like. Card information of an entrance card may include any of a user's name, a user's number (e.g., undergraduate number or staff number), an entrance history, and the like.

When the NFC module operates in a reader mode, the mobile terminal can read data from an external tag. The data received from the external tag by the mobile terminal may be coded into the NFC Data Exchange Format defined by the NFC Forum. The NFC Forum generally defines four record types. More specifically, the NFC Forum defines four Record Type Definitions (RTDs) such as smart poster, text, Uniform Resource Identifier (URI), and general control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or originate a call. If the data received from the external tag is a general control type, the controller may execute a proper operation according to control content.

In some cases in which the NFC module operates in a P2P(Peer-to-Peer) mode, the mobile terminal can execute P2P communication with another mobile terminal. In this case, Logical Link Control Protocol (LLCP) may be applied to the P2P communication. For P2P communication, connection may be generated between the mobile terminal and another mobile terminal. This connection may be categorized as a connectionless mode which ends after one packet is switched, and a connection-oriented mode in which packets are switched consecutively. For a typical P2P communication, data such as an electronic type name card, address information, a digital photo and a URL, a setup parameter for Bluetooth connection, Wi-Fi connection, etc. may be switched. The P2P mode can be effectively utilized in switching data of a small capacity, because an available distance for NFC communication is relatively short.

Further preferred embodiments will be described in more detail with reference to additional drawing figures. It is understood by those skilled in the art that the present features can be embodied in several forms without departing from the characteristics thereof.

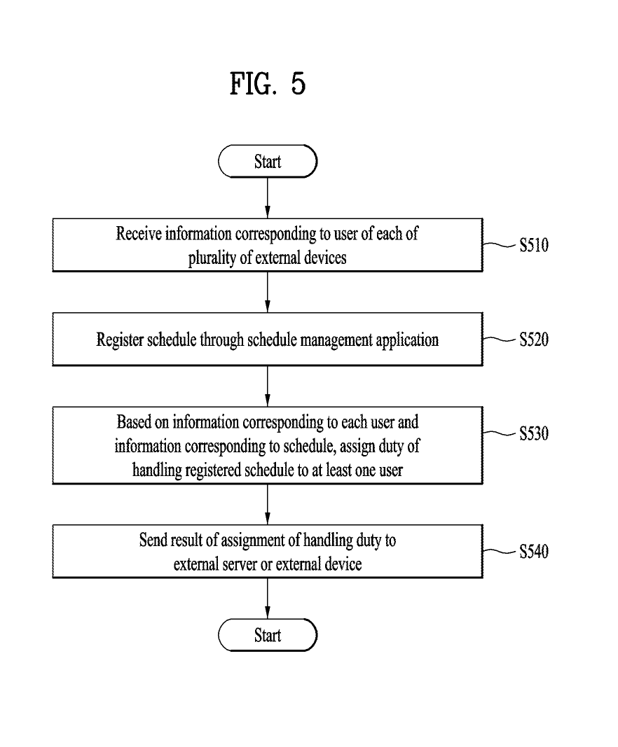

In the following description, if a schedule is registered through a schedule management application in a mobile terminal, methods of assigning a duty of handling the schedule to at least one of users of a plurality of mobile terminals interworking with each other according to embodiments of the present invention are described in detail with reference to FIGS. 5 to 15. Although the present specification is described by taking the mobile terminal 100 shown in FIG. 1A as one example, it is a matter of course that embodiments of the present invention are applicable to the mobile terminals 200, 300 and 400 described with reference to FIGS. 2 to 4.

FIG. 5 is a flowchart to describe one example of a method of if a schedule is registered through a schedule management application in a mobile terminal, assigning a duty of handling the schedule to at least one of a user of the mobile terminal and users of a plurality of external devices according to one embodiment of the present invention.

Referring to FIG. 5, the controller 180 of the mobile terminal 100 can control the wireless communication unit 110 to receive a 1^{st} information corresponding to a user of each of a plurality of external devices from an external server or a plurality of the external devices [S510]. In this case, the wireless communication unit 110 may include one of the mobile communication module 112, the wireless Internet module 113 and the short range communication module 114. Moreover, the external device is a device located outside the mobile terminal 100 and may have the configuration of one of the mobile terminals 100, 200, 300 and 400 described with reference to FIGS. 1 to 4. The external device may interwork with the mobile terminal 100. If the mobile terminal 100 and the external device interwork with each other, it may mean that the mobile terminal 100 and the external device can exchange informations with each other directly or indirectly through the external server.

A schedule management application is installed on the mobile terminal 100. And, a schedule management application is installed on each of a plurality of the external devices. In particular, the same schedule management application may be installed on each of the mobile terminal 100 and the external device. Alternatively, schedule management applications, which are inter-workable with each other despite differing from each other in part at least, may be installed on the mobile terminal 100 and the external device, respectively.

For instance, if the mobile terminal 100 receives the 1^{st} information corresponding to the user of each of a plurality of the external devices from the external server, the mobile terminal 100 and the external device may be configured in a manner of interworking with each other by exchanging data through the external server. For example, if a prescribed information is inputted through the schedule management application in the mobile terminal 100, the inputted information can be shared with a plurality of the external devices through the external server. In this case, the external device may be configured in form of a cloud server related to the schedule management application.

For another instance, if the mobile terminal 100 receives the 1^{st} information corresponding to the user of the corresponding external device from each of a plurality of the external devices, the mobile terminal 100 and each of the external devices may be configured in a manner of interworking with each other by exchanging data with each other without using the external server. For instance, if a prescribed information is inputted through the schedule management application in the mobile terminal 100, the inputted information can be sent to each of the external devices.

The 1^{st} information corresponding to the user of the external device may include at least one of a location information of the external device, a personal information of the user of the external device, a schedule information of the user of the external device, and a history information of the user of the external device. The personal information of the user of the external device may include at least one of a home address of the user of the external device, a company address of the user of the external device, a presence or non-presence of a car of the user of the external device, a home surrounding information of the user of the external device, a company surrounding information of the user of the external device, a commuting time information of the user of the external device, a commuting route information of the user of the external device, a hobby information of the user of the external device, a concernment information of the user of the external device, and a personality information of the user of the external device. The schedule information of the user of the external device may include an information of a schedule registered through the schedule management application installed on the external device. The history information of the user of the external device may include a life pattern information of the user of the external device, a user pattern information of the external device, and the like.

The controller 180 of the mobile terminal 100 receives the 1^{st} information from the external server or the external device and is able to update the previously received 1^{st} information, periodically or in case of reception of a request from the external server or the external device.

The mobile terminal 100 may include an information collecting unit configured to collect 2^{nd} information corresponding to the user of the mobile terminal 100. In this case, the information collecting unit may generically mean at least one of the wireless communication unit 110, the memory 170, the sensing unit 140 and the user input unit 123. Like the 1^{st} information, the 2^{nd} information corresponding to the user of the mobile terminal 100 may include at least one of a personal information of the user of the mobile terminal 100, a schedule information of the user of the mobile terminal 100, and a history information of the user of the mobile terminal 100. If the 2^{nd} information is collected, the controller 180 can control the wireless communication unit 110 to send the collected 2^{nd} information to the external server or a plurality of the external devices.

In case that at least one portion of the 2^{nd} information is changed over a preset level, or in accordance with a preset period, the controller 180 can control the wireless communication unit 110 to send a signal containing the changed matter of the 2^{nd} information to the external server or a plurality of the external devices. Hence, the external server or the external device can update the 2^{rd} information. In particular, each of the external server and the external device stores information corresponding to a user of a plurality of devices (e.g., the mobile terminal 100 included) and is able to update the stored information.

If the schedule is registered through the schedule management application, the controller 180 of the mobile terminal 100 can detect a 3^{rd} information corresponding to the registered schedule [S520].

The user of the mobile terminal 100 can register a desired schedule at the schedule management application. Although the present embodiment is described in aspect of the mobile terminal 100, a user of an external device can register a desired schedule at a schedule management application through an external device of the user as well.

The 3^{rd} information corresponding to the registered schedule may contain a content of the schedule, a date on which the schedule will be executed, a day of the week on which the schedule will be executed, an hour at which the schedule will be executed, a place at which the schedule will be executed, and the like. According to an embodiment, when a schedule is registered through the schedule management application, the controller 180 may receive an information for selecting at least one user, who will be exempted from the duty of handling the registered schedule, and/or at least one user, to which the handling duty of the registered schedule will be given, from the user of the mobile terminal 100 and the user of the external device.

The 3^{rd} information corresponding to the registered schedule may include at least one of an information directly inputted through the schedule management application by the user of the mobile terminal 100 on registering the schedule and an information extracted from the information previously saved in the memory 170.

Based on the 1^{st} information and the 3^{rd} information, the controller 180 can assign the duty of handling the registered schedule to at least one of the user of the mobile terminal 100 and the users of a plurality of the external devices [S530]. According to an embodiment, when the controller 180 assigns the duty of handling the registered schedule, the controller 180 may further refer to the 2^{rd} information. Based on the 1^{st} information and the 3^{rd} information, the controller 180 determines a user appropriate for handling the registered schedule from the user of the mobile terminal 100 and the users of a plurality of the external devices and is then able to assign the duty of handling the registered schedule to the determined user. According to an embodiment, the controller 180 may assign the duty of handling the registered schedule to the user of each of a plurality of the external devices by excluding the user of the schedule registered mobile terminal 100.

Subsequently, the controller 180 may control the wireless communication unit 110 to send a result of the handling duty assignment to the external server or a plurality of the external devices [S540]. Thus, a plurality of the external devices except the mobile terminal 100 can share an information indicating what is the registered schedule and an information indicating that the duty of handling the registered schedule is assigned to which user with each other.

According to the present embodiment, the following advantages can be provided. First of all, the user of the mobile terminal 100 assigns an appropriate schedule to other people as well as manages a schedule of his own. Secondly, the user of the mobile terminal 100 can manage a joint schedule and other people's schedules together.

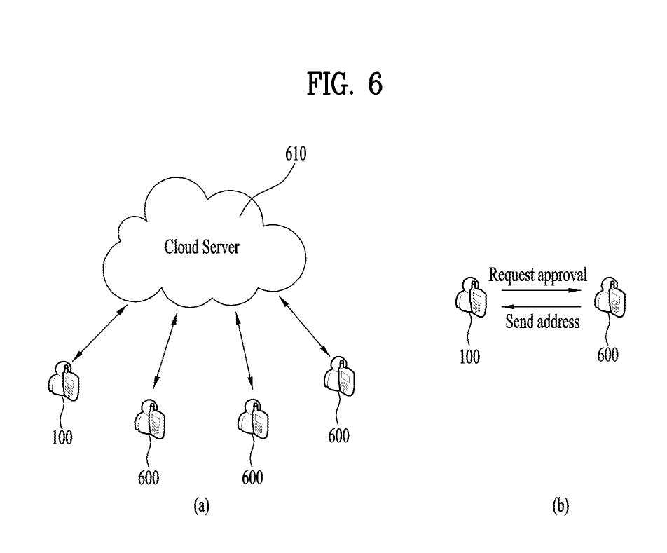

FIG. 6 is a diagram to describe one example of a method of sharing information for schedule management between a mobile terminal and an external device according to one embodiment of the present invention.

For instance, referring to FIG. 6(a), a mobile terminal 100 and an external device 600 can share data with each other through an external server 610. According to an embodiment, the external server 610 may include a cloud server having a storage space. The controller 180 of the mobile terminal 100 can send an information inputted through a schedule management application and an information corresponding to a user of the mobile terminal 100 to the external server 610 through the wireless communication unit 110. And, the controller 180 of the mobile terminal 100 can receive an information related to the schedule management application and an information corresponding to a user of the external device 600 from the external server 610 through the wireless communication unit 110. Likewise, the external device 600 sends an information inputted through a schedule management application and an information corresponding to the user of the external device 600 to the external server 610 and is able to receive the information related to the schedule management application, the information corresponding to the user of the mobile terminal 100, and an information corresponding to a user of another external device 600,

For another instance, referring to FIG. 6(b), the mobile terminal 100 and the external device 600 can share data with each other without using the external server 610 related to the schedule management application. The mobile terminal 100 and the external device 600 can perform a procedure for allowing the data sharing for the schedule management according to one embodiment of the present invention to each other in advance. For example, the mobile terminal 100 sends a 1^{st} signal for requesting the data sharing for the schedule management to the external device 600. In response to the 1^{st} signal, the external device 600 can send a 2^{nd} signal for accepting the data sharing for the schedule management to the mobile terminal 100. In this case, the 2^{nd} signal may contain an access address information accessible to the external device 600. The controller 180 of the mobile terminal 100 can send the information inputted through the schedule management application and the information corresponding to the user of the mobile terminal 100 to the external device 600 through the wireless communication unit 110. Moreover, the controller 180 of the mobile terminal 100 can receive the information related to the schedule management application and the information corresponding to the user of the external device 600 from the external device 600 through the wireless communication unit 100.

The following description shall be made on the assumption of a scheme that the mobile terminal 100 and the external device 600 share data through the external server 610 like FIG. 6(a).

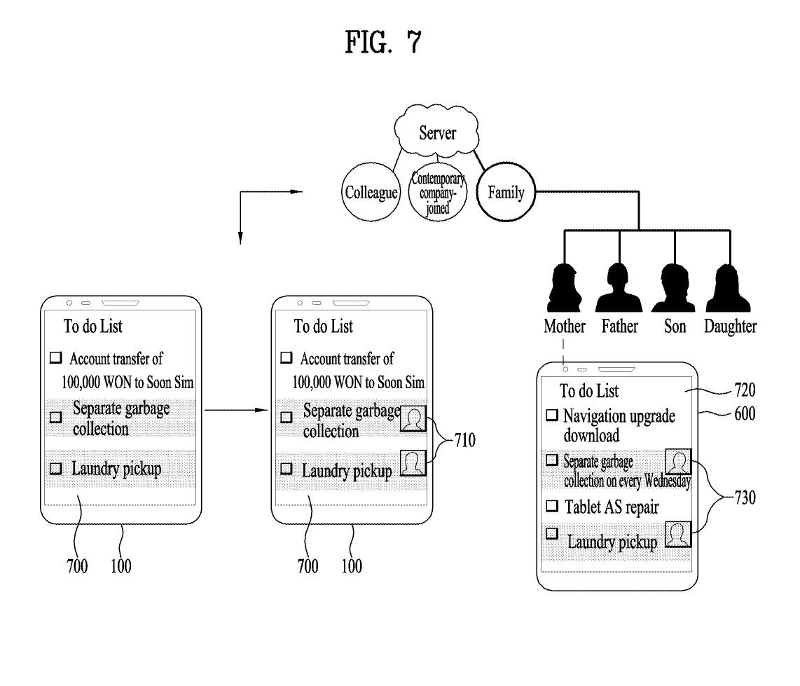

FIG. 7 is a diagram to describe one example of a method of if a schedule is registered through a schedule management application in a mobile terminal, assigning a duty of handling the schedule to at least one of a user of the mobile terminal and users of a plurality of external devices according to one embodiment of the present invention. Details redundant with the contents mentioned in the foregoing description with reference to FIG. 5 shall be omitted from the following description.

Referring to FIG. 7, the user of the mobile terminal 100 can register a desired schedule using a schedule management application installed on the mobile terminal 100. According to the present embodiment, assume that the user of the mobile terminal 100 newly registers a separate garbage collection schedule (i.e., 1^{st} schedule) and a laundry pickup schedule (i.e., 2^{nd} schedule).

Meanwhile, the controller 180 of the mobile terminal 100 can control the wireless communication unit 110 to receive a 1^{st} information corresponding to a user of each of a plurality of the external devices 600 from an external server. According to an embodiment, a plurality of the external devices 600 may be sorted into a plurality of groups (e.g., colleague group, contemporary company-joined group, family group, etc.) in accordance with a preset condition. And, the 1^{st} information may further include a group information indicating that each of the external devices belongs to which group. For instance, the 1^{st} information can be periodically sent to the mobile terminal 100 from the external server. For another instance, the 1^{st} information can be sent to the mobile terminal 100 from the external server each time the external device 600 sends information to the external server. For further instance, the 1^{st} information can be sent to the mobile terminal 100 from the external server if the information, which corresponds to the user of the external device 600 and is saved in the external server, is changed over a preset level.

The controller 180 of the mobile terminal 100 can collect (or obtain) a 2^{nd} information corresponding to the user of the mobile terminal 100. For examples of the 2^{nd} information, the controller 180 may collect a location information of the mobile terminal 100 through the location information module 115, a personal information of the user of the mobile terminal 100 from the information previously saved in the memory 170, a history information of the user of the mobile terminal 100, and a schedule information of the user of the mobile terminal 100 from the information previously registered at a schedule management application or a memo application.

Based on at least one of the 1^{st} information, the 2^{nd} information, and a 3^{rd} information corresponding to a schedule registered through the schedule management application, the controller 180 can assign the duty of handling the 1^{st} schedule and the 2^{nd} schedule to at least one of the user of the mobile terminal 100 and a user corresponding to each of a plurality of the external devices 600.

In particular, based on the 3^{rd} information, the controller 180 can derive the requirements necessary for performing (or, handling) the registered schedule. For instance, the controller 180 can derive the requirements such as ‘the registered schedule should be performed by which group’, ‘when/where the registered schedule should be performed’, ‘whether the registered schedule can be performed by a single person or several persons together’, ‘whether a car is required for performing the registered schedule’, ‘what kind of knowledge is required for performing the registered schedule’, and the like. For instance, in case that the 1^{st} schedule should be performed around home in the morning on Wednesday every week, the controller 180 can assign the duty of handling the 1^{st} schedule to mother having no separate schedule in the morning on Wednesday every week.

For another instance, if the 2^{nd} schedule should be performed at specific place in the evening on Friday this week, the controller 180 can assign the duty of handling the 2^{nd} schedule to father scheduled to pass around the specific place at a quitting time on Friday this week.

According to an embodiment, if there are a plurality of registered schedules and at least two of the registered schedules are similar to each other in schedule type. schedule attribute, schedule feature and the like, the controller 180 may assign the duty of handling the at least two registered schedules to the same user.

According to an embodiment, if the assignment of the duty of handling the registered schedule is completed, the controller 180 can display an indicator 710, which indicates the user having the handling duty assigned thereto among the user of the mobile terminal 100 and the user of each of a plurality of the external devices 600, on a running screen 700 of the schedule management application. For example, regarding the running screen 700 of the schedule management application, if at least one portion of the 2^{nd} information corresponding to the registered schedule is displayed and the assignment of the duty of handling the registered schedule is completed, the indicator 710 can be displayed to correspond to the information of the corresponding schedule.

The controller 180 can control the wireless communication unit 110 to send a result of the assignment of the handling duty to the external server.

The external device 600 belonging to a specific group (e.g., family group) related to the registered schedule can receive the result of the assignment of the handling duty from the external server. According to an embodiment, if receiving the result of the assignment of the handling duty from the external server, the external device 600 corresponding to the user (e.g., mother, father, etc.) having the handling assignment assigned thereto may display a notification message, which indicates that the duty of handling the registered schedule was assigned, on the display unit.

If the schedule management application is run, the external device 600 outputs a running screen 720 of the schedule management application to the display unit and is able to display an indicator 730, which indicates the handling duty assigned user, on the running screen 720. In this case, the running screen 720 may include only an information corresponding to a schedule related to the user of the external device 600 or may include an information corresponding to a schedule related to the user of each of a plurality of the external devices 600 belonging to a specific group to which the user of the external device 600 belongs.

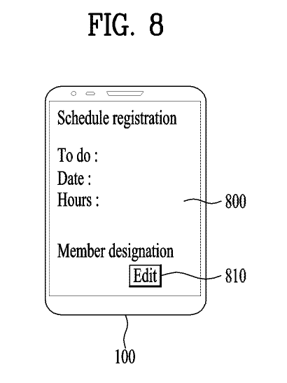

FIG. 8 is a diagram to describe one example of a method of registering a schedule through a schedule management application in a mobile terminal according to one embodiment of the present invention.

Referring to FIG. 8, if a schedule management application is run, the controller 180 of the mobile terminal 100 can display a running screen 800 of the schedule management application on the display unit 151. In this case, the running screen 800 may include a screen for registering a new schedule.

A user is able to register a desired schedule (e.g., a job to do) at the schedule management application. The controller 180 may receive at least one portion of a 3^{nd} information corresponding to the schedule through the schedule management application. For example, the 3^{rd} information may include a content of the schedule, a date on which the schedule will be executed, a day of the week on which the schedule will be executed, an hour at which the schedule will be executed, a place at which the schedule will be executed, and the like.

According to an embodiment, when the schedule is registered through the schedule management application, the controller 180 may receive an information for selecting at least one user, who will be exempted from the duty of handling the registered schedule, and/or at least one user, to which the handling duty of the registered schedule will be given, from the user of the mobile terminal 100 and the user of the external device 600. For example, through a menu 810 for designating a user related to the duty of handling the registered schedule on the running screen 800, the user can select at least one user, who will be exempted from the duty of handling the registered schedule, and/or at least one user, to which the handling duty of the registered schedule will be given, from the user of the mobile terminal 100 and the user of the external device. Besides, in response to a command for selecting the menu 810, the controller 180 can display a list of a plurality of the external devices 600 interworking with the mobile terminal 100 or a list of at least one external device 600 belonging to the specific group corresponding to the registered schedule on the display unit 151 [not shown in the drawing].

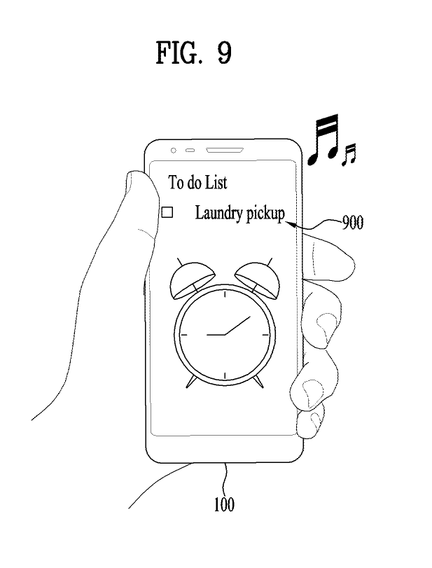

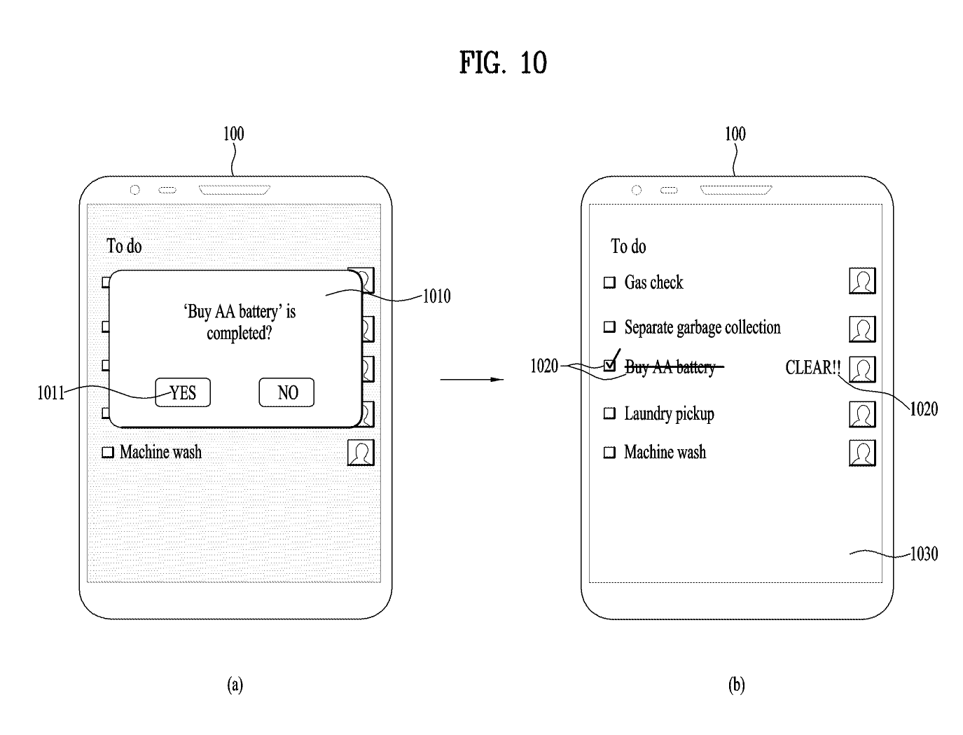

FIG. 9 is a diagram to describe one example of a method of providing a notification of a schedule registered in a mobile terminal according to one embodiment of the present invention. According to the description with reference to FIG. 9, assume a case that a duty of handling the registered schedule is assigned to a user of the mobile terminal 100.

Referring to FIG. 9, a 3^{rd} information corresponding to a schedule assigned to the user of the mobile terminal 100 is currently saved in the memory 170 of the mobile terminal 100. For example, as a 3^{rd} information corresponding to the schedule assigned to the user of the mobile terminal 100, the memory 170 may currently store a place at which the schedule will be executed, a date on which the schedule will be executed, a day of the week on which the schedule will be executed, an hour at which the schedule will be executed, and the like.

When the duty of handling the registered schedule is assigned to the user of the mobile terminal 100 or the notification of the registered schedule is set, if the mobile terminal 100 is located in a preset range from a place corresponding to the registered schedule based on the 3^{rd} information and the location information of the mobile terminal 100 obtained through the location information module 115, the controller can display a notification message 900 for guiding the user to perform the registered schedule on the display unit 151.

According to an embodiment, the controller 180 may output a preset audio data for sound notification and/or a preset vibration data for vibration notification through the audio output unit 152 and/or the haptic module 153 together with the notification message 900.

FIG. 10 is a diagram to describe one example of a method of detecting a completion of a schedule registered in a mobile terminal according to one embodiment of the present invention. According to the description with reference to FIG. 10, assume a case that a duty of handling the registered schedule is assigned to a user of the mobile terminal 100.

Referring to FIG. 10, if the duty of handling the registered schedule is assigned to the user of the mobile terminal 100, the controller 180 of the mobile terminal 100 can detect a completion (e.g., an execution completion, a handling completion) of the registered schedule by the user of the mobile terminal 100 based on a 2^{nd} information corresponding to the user of the mobile terminal 100 and a 3^{rd} information corresponding to the registered schedule. If the completion of the registered schedule is detected, the controller 180 can display an indicator, which indicates the completion of the registered schedule, on a running screen of a schedule management application.

According to an embodiment, if the completion of the registered schedule is detected, the controller 180 displays a message, which is provided to confirm the completion of the registered schedule, on the display unit 151. If the completion of the registered schedule is confirmed, the controller 180 may display an indicator, which indicates the completion of the registered schedule, on the running screen of the schedule management application.

According to an embodiment, in determining a presence or non-presence of the completion of the registered schedule, based on the 3^{rd} information and a location information of the mobile terminal 100, if the mobile terminal 100 stays at a place corresponding to the registered schedule over a preset time at the hour and date corresponding to the registered schedule, i.e., if a value of the location information of the mobile terminal 100 at the hour and date corresponding to the registered schedule corresponds to the information of the place corresponding to the registered schedule over the preset time, the controller 180 can detect that the registered schedule is completed by the user of the mobile terminal 100.

For instance, referring to FIG. 10(a), based on at least one portion in the 2^{rd} information corresponding to the user of the mobile terminal 100 and the 3^{rd} information corresponding to the registered schedule, if the completion of the registered schedule by the user of the mobile terminal 100 is detected, the controller 180 can display a message 1010, which is provided to confirm the completion of the registered schedule, on the display unit 151. In this case, the message 1010 may be displayed on the running screen of the schedule management application. Alternatively, if a different content is displayed on the display unit 151, the message 101 may be displayed on the different content.

Referring to FIG. 10(a) and FIG. 10(b), if a confirm menu 1011 is selected from the message 1010, the controller 180 can display an indicator 1020, which indicates the completion of the registered schedule, on the display unit. For example, if the confirm menu 1011 in the message 1010 is selected, the controller 180 runs the schedule management application and is then able to display the indicator 1020 on a running screen 1030 of the schedule management application.

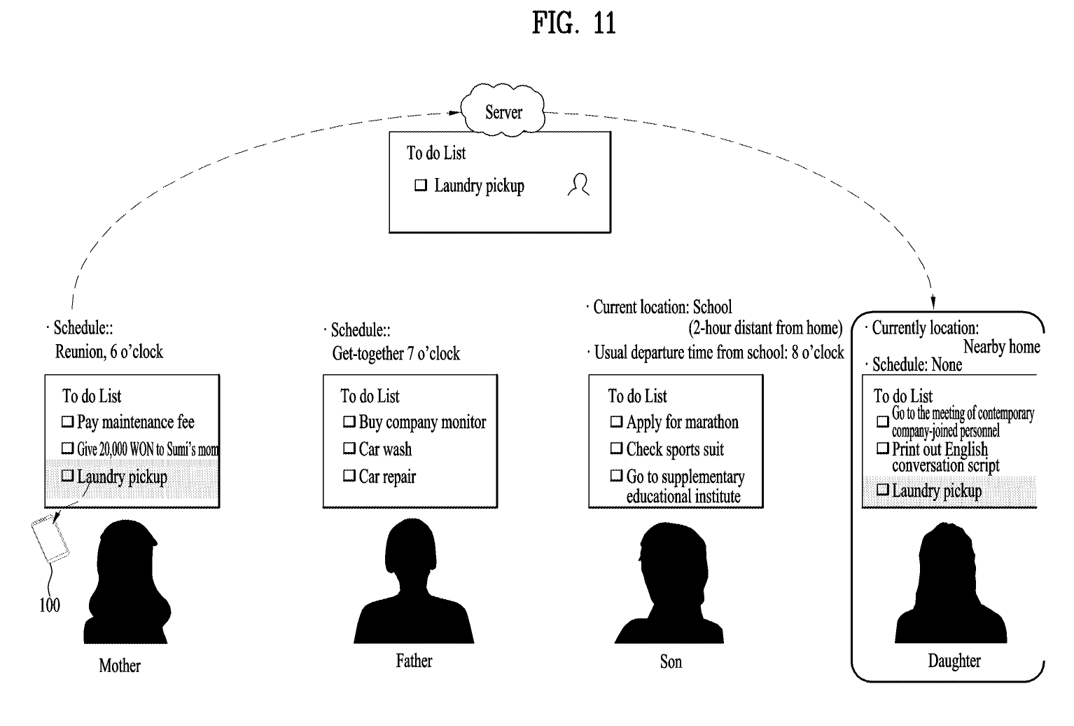

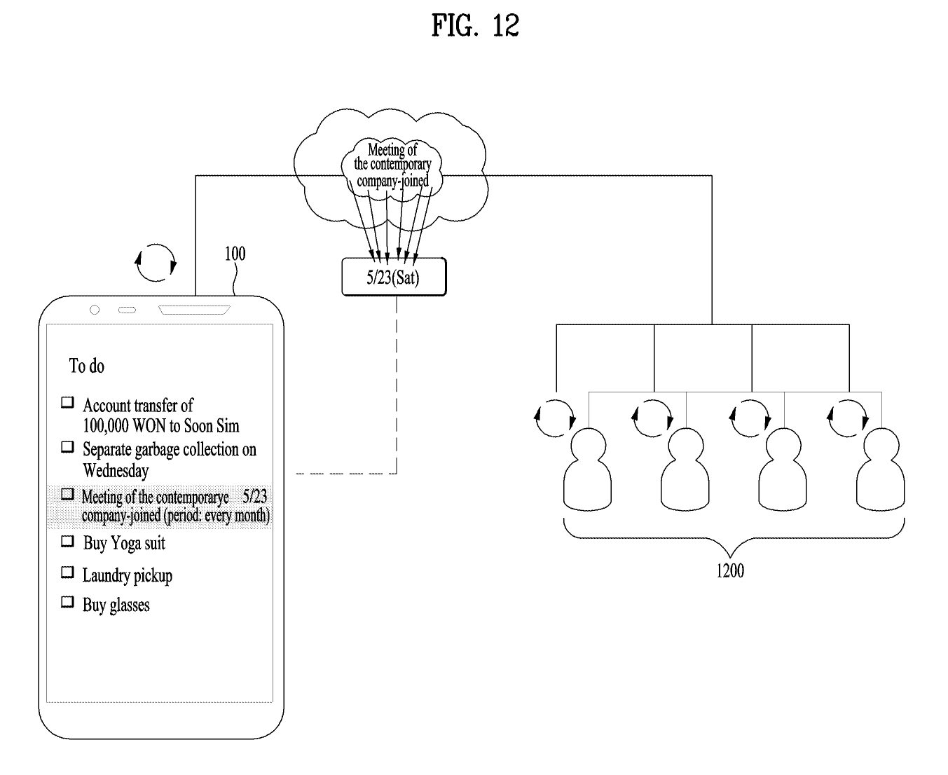

FIG. 11 is a diagram to describe one example of a method of if a schedule is registered through a schedule management application in a mobile terminal, assigning a duty of handling the schedule to at least one of a user of the mobile terminal and users of a plurality of external devices according to one embodiment of the present invention.

According to the present embodiment, assume a case that a user (e.g., mother) of the mobile terminal 100 belonging to a family group registers a schedule (e.g., pick up the laundry) through a schedule management application. And, assume a case that a duty of handling the schedule is assigned to at least one of the user (e.g., mother) of the mobile terminal 100 belonging to the family group and users (e.g., father, son, daughter, etc) of a plurality of external devices 600.

Referring to FIG. 11, the controller 180 of the mobile terminal 100 can control the wireless communication unit 110 to receive a 1^{st} information corresponding to a user of each of a plurality of external devices 600 belonging to a family group from an external server. In this case, the 1^{st} information may include a current location in formation of the external device 600, a schedule information of a user of the external device 600, a personal information (e.g., a commuting time, a commuting-to-school time, etc.) of the user of the external device 600, and the like.

The controller 180 of the mobile terminal 100 can collect a 2^{nd} information (e.g., a location information of the mobile terminal 100, a schedule information of the user of the mobile terminal 100, etc.) corresponding to the user (e.g., mother) of the mobile terminal 100.

On the other hand, if a laundry pickup schedule is registered through the schedule management application, the controller 180 of the mobile terminal 100 can obtain a 3^{rd} information corresponding to the registered schedule. In this case, the 3^{rd} information may be obtained from an information inputted through the schedule management application and an information previously saved in the memory 170. According to an embodiment, in obtaining the 3^{rd} information, the controller 180 of the mobile terminal 100 can additionally refer to an internet sear result based on the information inputted through the schedule management application and the information previously saved in the memory 170.

Based on at least one portion of the 1^{st} information, the 2^{nd} information and the 3^{rd} information, the controller 180 of the mobile terminal 100 can assign a duty of handling the registered schedule to a user appropriate for handling the registered schedule among users belonging to a family group. For example, the controller 180 of the mobile terminal 100 can assign the duty of handling the registered schedule to a daughter in consideration of current locations of the users belonging to the family group, a location of a laundry shop, operation hours of the laundry shop, a distance between the laundry shop and the current location of each of the users, a schedule of each of the users, and the like.

The controller 180 of the mobile terminal 100 controls the wireless communication unit 110 to send a result of the assignment of the handling duty to the external server. Subsequently, the external server can send the result of the assignment of the handling duty to the external device 600 belonging to the family group.

FIG. 12 is a diagram to describe one example of a method of if a schedule is registered through a schedule management application in a mobile terminal, determining a date appropriate for performing the registered schedule according to one embodiment of the present invention. Details redundant with the contents mentioned in the foregoing description shall be omitted from the following description.

Referring to FIG. 12, if a schedule (e.g., a monthly meeting of contemporary company-joined people) is registered through a schedule management application, the controller 180 of the mobile terminal 100 can assign a duty of performing (handling) the registered schedule to a user appropriate for performing the registered schedule among users belonging to a specific group (e.g., contemporary company-joined group, etc.) based on the 1^{st} to 3^{rd} informations mentioned in the foregoing description. According to an embodiment, the user of the mobile terminal 100 may designate at least one user to perform the schedule in registering the schedule.

If the registered schedule is related to a plurality of users 1200 including the user of the mobile terminal 100, the controller 180 can determine a date on which the registered schedule will be performed as a date appropriate for a plurality of users 1200 all based on an information corresponding to the registered schedule and an information (e.g., a schedule information of each of the users) corresponding to each of the users. For example, if the schedule is registered to be performed (handled) in May, the controller 180 can determine a date, on which each of the users has no schedule, of weekends of May as the date on which the schedule will be performed.

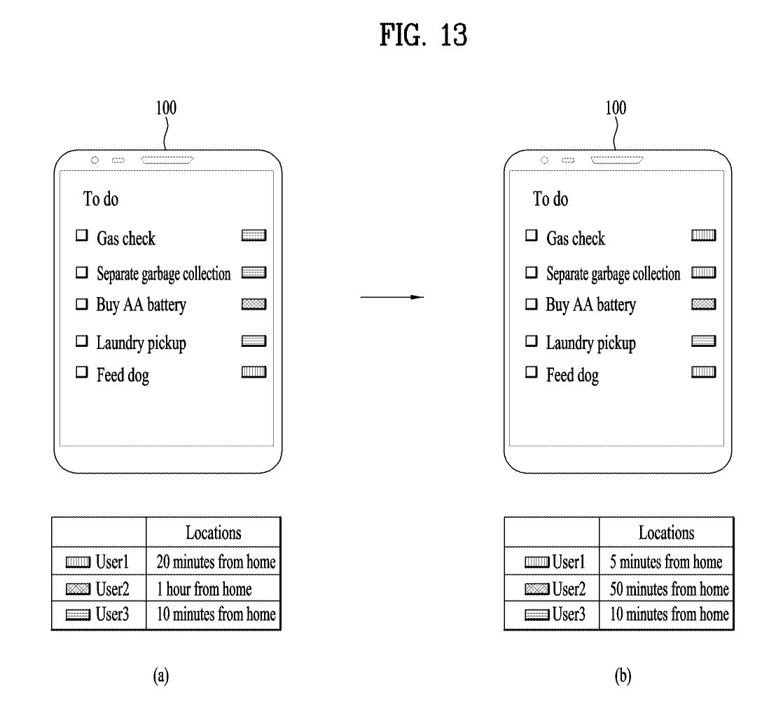

FIG. 13 is a diagram to describe another example of a method of if a schedule is registered through a schedule management application in a mobile terminal, assigning a duty of handling the schedule to at least one of a user of the mobile terminal and users of a plurality of external devices according to one embodiment of the present invention. Details redundant with the contents mentioned in the foregoing description shall be omitted from the following description.

Referring to FIG. 13(a), based on at least one portion of a 1^{st} information corresponding to a user of the external device 600, a 2^{nd} information corresponding to a user of the mobile terminal 100 and a 3^{rd} information corresponding to a registered schedule, the controller 180 of the mobile terminal 100 computes a priority of a user appropriate for handling the registered schedule between the user of the mobile terminal 100 and the user of the external device 600 and is then able to assign a duty of handling the registered schedule to the user having a higher priority. According to an embodiment, in computing the user's priority, a distance between a current location of each user and a place for performing each schedule and a schedule of each user can be considered as most significant factors, by which the present invention is non-limited.

Referring to FIG. 13(b), the controller 180 of the mobile terminal 100 can update the 1^{st} information and the 2^{nd} information periodically or aperiodically. For example, the controller 180 of the mobile terminal 100 re-receives the 1^{st} information from the external server and is then able to update the 1^{st} information previously saved in the memory 170 into the re-received 1^{st} information. Based on the updated 1^{st} information and the updated 2^{nd} information, if the priority of the user appropriate for handling the registered schedule between the user of the mobile terminal 100 and the user of the external device 600 is changed, the controller 180 can change the user for handling the registered schedule based on the changed priority. If the user for handling the registered schedule is changed, the controller 180 can control the wireless communication unit 110 to send a signal containing the changed information to the external server.

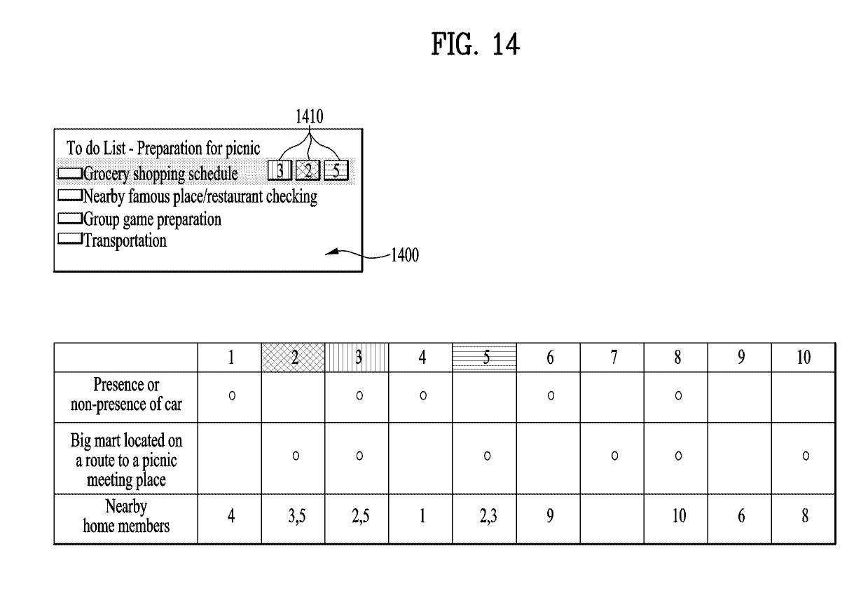

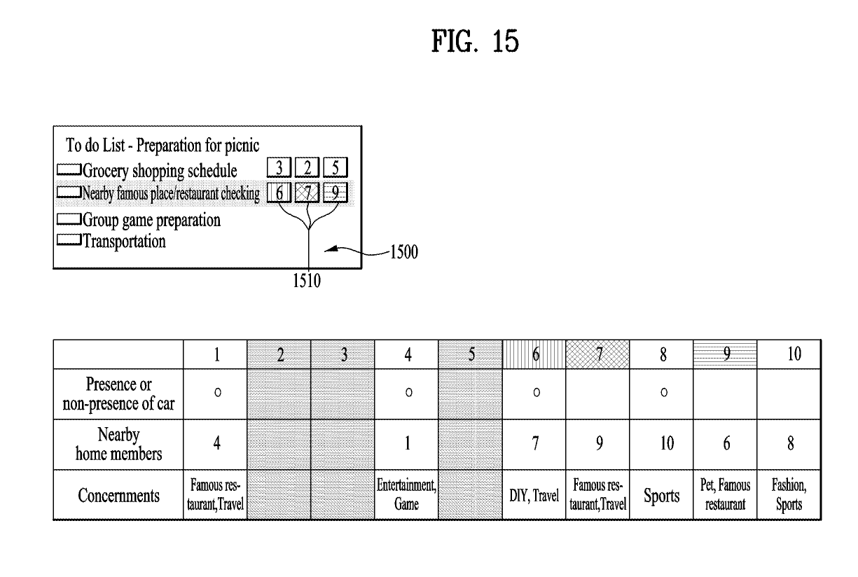

FIG. 14 and FIG. 15 are diagrams to describe one example of a method of if a schedule is registered through a schedule management application in a mobile terminal, assigning a duty of handling the schedule to at least one of a user of the mobile terminal and users of a plurality of external devices according to one embodiment of the present invention. Details redundant with the contents mentioned in the foregoing description shall be omitted from the following description.

First of all, according to the present embodiment, a method of assigning a duty of handling a grocery shopping schedule (i.e., 1^{st} schedule) and a place/restaurant checking schedule (i.e., 2^{nd} schedule) is taken as an example of a schedule for preparing for a picnic.

The controller 180 of the mobile terminal 100 can control the wireless communication unit 110 to receive a 1^{st} information corresponding to a user of each of a plurality of external devices 600 belonging to a specific group from an external server. And, the controller 180 can collect a 2^{nd} information corresponding to a user (or member) of the mobile terminal 100. According to the present embodiment, assume that the total number of the user of the mobile terminal 100 and the users of the external devices 600 is 10. And, each of the users shall be named a member. Moreover, each of the users shall be named Member #1, Member #2, Member #3 . . . or the like.

The controller 180 can obtain a 3^{nd} information corresponding to 1^{st} and 2^{nd} schedules registered through a schedule management application. In this case, the 3^{nd} information may include at least one of an information inputted through the schedule management application, an information previously saved in the memory 170, and an information obtained from a search through Internet.

Referring to FIG. 14, based on the 1^{st} to 3^{rd} informations, the controller 180 can derive requirements necessary for performing the 1^{st} schedule. For example, the controller 180 can derive the requirements such as ‘a presence or non-presence of a car necessary for performing the 1^{st} schedule’ [1^{st} condition], ‘whether a mart is located on a route from a nearby place of a home of each member or a home of each member to a picnic meeting place’ [2^{nd} condition], the number of members necessary for performing the 1^{st} schedule, and the like.

Referring to the table shown in FIG. 14, when each of Member #3 and Member #8 meets both of the 1^{st} condition and the 2^{nd} condition, the controller 180 can assign a duty of handling the 1^{nd} schedule to Members #3, #2 and #5 (e.g., members having homes located close to each other) who are appropriate for performing the 1^{st} schedule together.

Subsequently, the controller 180 can control the wireless communication unit 110 to send a result of the assignment of the duty of handling the 1^{st} schedule to the external server. And, the controller 180 can display an indicator 1410, which indicates the result of the assignment of the duty of handling the 1^{st} schedule, on a running screen 1400 of the schedule management application.

Referring to FIG, 15, based on the 1^{st} to 3^{rd} informations, the controller 180 can derive requirements necessary for performing the 2^{nd} schedule. For example, the controller 180 can derive the requirements such as ‘a presence or non-presence of a car necessary for performing the 2^{nd} schedule, a concernment information of each member, a concernment matched member information, the number of members necessary for performing the 2^{nd} schedule, and the like.

Referring to the table shown in FIG. 15, the controller 180 can assign a duty of handling the 2^{nd} schedule to Members #6, #7 and #9 including the member having a home located nearby with a car among the concernment matched members.

Subsequently, the controller 180 can control the wireless communication unit 110 to send a result of the assignment of the duty of handling the 2^{nd} schedule to the external server. And, the controller 180 can display an indicator 1510, which indicates the result of the assignment of the duty of handling the 2^{nd} schedule, on a running screen 1500 of the schedule management application.

According to the embodiments mentioned in the foregoing description, it is able to provide a solution for assigning a duty of handling a schedule to a user most appropriate for performing a prescribed schedule among users of a plurality of mobile terminals interworking with each other if the prescribed schedule is registered through a schedule management application.

The present invention mentioned in the foregoing description can be implemented in a program recorded medium as computer-readable codes. The computer-readable media may include all kinds of recording devices in which data readable by a computer system are stored. The computer-readable media may include HDD (Hard Disk Drive), SSD (Solid State Disk), SDD (Silicon Disk Drive), ROM, RAM, CD-ROM, magnetic tapes, floppy discs, optical data storage devices, and the like for example and also include carrier-wave type implementations (e.g., transmission via Internet). Further, the computer may include the controller 180 of the terminal. It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

### DETAILED DESCRIPTION OF THE INVENTION

As described in detail in the best mode for carrying out the invention, those skilled in the art can refer to it,

### INDUSTRIAL APPLICABILITY

The present invention relates to a mobile terminal and is industrially usable,

1. A mobile terminal, comprising:
a display unit configured to display information related to the mobile terminal:
a wireless communication unit configured to receive first information corresponding to a user of each of a plurality of external devices from an external server or a plurality of the external devices, wherein the first information includes at least one of location information of the external device, personal information of the user of the external device, schedule information of the user of the external device, or history information of the user of the external device; and
a controller configured to:
execute a schedule management application,
control the display unit to display an execution screen of the executed schedule management application,
assign a duty of handling the registered schedule to at least one of a user of the mobile terminal and the user of each of the plurality of the external devices based on the received first information and second information corresponding to a schedule registered via the schedule management application, and
control the wireless communication unit to transmit a result of the assignment of the handling duty assignment to the external server or the plurality of the external devices.

2. The mobile terminal of claim 1, wherein:
the controller is further configured to control the display unit to display at least one portion of the second information on the execution screen of the schedule management application, and
when the assignment of the handling duty is completed, control the display unit to display an indicator indicating the user having the handling duty assigned thereto among the user of the mobile terminal and the user of each of the plurality of the external devices on the execution screen of the schedule management application.

3. The mobile terminal of claim 1, further comprising:
an information collecting unit configured to collect third information corresponding to the user of the mobile terminal,
wherein third information includes at least one location information of the mobile terminal, personal information of the user of the mobile terminal, schedule information of the user of the mobile terminal, or history information of the user of the mobile terminal,
wherein the controller is further configured to control the wireless communication unit to transmit the collected third information to the external server or the plurality of the external devices, and wherein in accordance with a change of the third information over a preset level or a preset period, the controller is further configured to control the wireless communication unit to transmit a signal including a matter of the change of the third information to the external server or the plurality of the external devices.

4. The mobile terminal of claim 1, wherein:
the plurality of the external devices are sorted into a plurality of groups in accordance with a preset condition,
the first information further comprises group information indicating each of the external devices belongs to a prescribed one of the plurality of the groups,
the controller is further configured to determine that the registered schedule corresponds to a prescribed one of the plurality of the groups based on the second information, and when the registered schedule corresponds to a first one of a plurality of the groups, based on the first information and the second information, assign the duty of handling the registered schedule to at least one user belonging to the first group among the user of the mobile terminal and the users of the plurality of the external devices.

5. The mobile terminal of claim 3, wherein:
when the duty of handling the registered schedule is assigned to the user of the mobile terminal, the controller is further configured detect a completion of the registered schedule by the user of the mobile terminal based on at least one portion of the second information and the third information and
when the completion of the registered schedule is detected, the controller is further configured to control the display unit to display an indicator indicating the completion of the registered schedule on the execution screen of the schedule management application.

6. The mobile terminal of claim 5, wherein:
when the completion of the registered schedule is detected, the controller is further configured to control the display unit to display a message for confirming the completion of the registered schedule and
when the completion of the registered schedule is confirmed via the message, the controller is further configured to control the display unit to display the indicator indicating the completion of the registered schedule on the execution screen of the schedule management application.

7. The mobile terminal of claim 5, further comprising:
a location information module configured to obtain the location information of the mobile terminal,
wherein when the mobile terminal stays at a place corresponding to the registered schedule at an hour corresponding to the registered schedule on a date corresponding to the registered schedule over a preset time based on the second information and the obtained location information, the controller is further configured to detect the completion of the registered schedule by the user of the mobile terminal.

8. The mobile terminal of claim 1, wherein when information corresponding to the schedule is inputted through the schedule management application, the controller is further configured to receive information for selecting at least one user who will be exempted from the duty of handling the registered schedule or at least one user to which the handling duty of the registered schedule will be given from the user of the mobile terminal and the user of each of the plurality of the external devices.

9. The mobile terminal of claim 1, further comprising:
a location information module configured to obtain the location information of the mobile terminal,
wherein when the duty of handling the registered schedule is assigned to the user of the mobile terminal and the mobile terminal is located in a preset range from a place corresponding to the registered schedule at an hour corresponding to the registered schedule on a date corresponding to the registered schedule based on the second information and the obtained location information, the controller is further configured to control the display unit to display a notification message on the display unit to lead an execution of the registered schedule.

10. The mobile terminal of claim 1, wherein:
the controller is further configured to compute a priority of a user appropriate for handling the registered schedule among the user of the mobile terminal and the user of the plurality of the external devices based on the 1st information and the 2nd information and
assign the duty of handling the registered schedule to the user having the priority computed as a top priority,

11. The mobile terminal of claim 10, wherein:
the controller is further configured to receive the first information through the wireless communication unit and
when the priority of the user appropriate for handling the registered schedule among the user of the mobile terminal and the user of each of a plurality of the external devices is changed based on the re-received first information and the second information, the controller is further configured to change a user to whom the handling duty will be assigned based on the changed priority.

12. The mobile terminal of claim 3, wherein when the registered schedule is related to a plurality of users on the basis of the second information, the controller is further configured to determine a date for performing the registered schedule as a date appropriate for a plurality of the users all based on a schedule information of each user included in the first information and the third information.

13. The mobile terminal of claim 1, wherein the second information includes at least one of information inputted by the user on registering the schedule through the schedule management application and information extracted from an information previously saved in a memory.

14. The mobile terminal of claim 1, wherein the personal information of the user of the external device includes at least one of a home address of the user of the external device, a company address of the user of the external device, a presence or non-presence of a car of the user of the external device, a home surrounding information of the user of the external device, a company surrounding information of the user of the external device, a commuting time information of the user of the external device, a commuting route information of the user of the external device, a hobby information of the user of the external device, a concernment information of the user of the external device, or a personality information of the user of the external device.

15. A method of controlling a mobile terminal, the comprising:
receiving first information corresponding to a user of each of a plurality of external devices from an external server or a plurality of the external devices, wherein the first information comprising at least one of a location information of the external device, a personal information of the user of the external device, a schedule information of the user of the external device, or a history information of the user of the external device;
executing a schedule management application;
assigning a duty of handling the registered schedule to at least one of a user of the mobile terminal and the user of each of the plurality of the external devices based on the received first information and second information corresponding to a schedule registered through the schedule management application; and
transmitting a result of the assignment of the handling duty assignment to the external server or the plurality of the external devices.
